(19) United States
(12) Patent Application Publication
(10) Pub. No.: US 2006/0270434 A1
(43) Pub. Date: Nov. 30, 2006

(54) Uplink power control optimization for a switched beam wireless transmit/receive unit

(75) Inventor: Ana Lucia Iacono, Garden City, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/216,817

(22) Filed: Aug. 31, 2005

Related U.S. Application Data
(60) Provisional application No. 60/685,246, filed on May 27, 2005.

(51) Int. Cl. H04B 7/00; H04Q 7/20

(52) U.S. Cl. 455/522

(57) ABSTRACT

The present invention is a method for adjusting the uplink transmission power of a WTRU utilizing a switched beam antenna. The method measures the received power of a pilot channel beacon in order to estimate the path loss associated with each directional antenna beam. A beam correction function is calculated based on an estimated gain difference between the beam which is currently used for transmission and the beam to which the WTRU will switch. The transmission power of the WTRU is adjusted according to the beam correction function at the time of beam switching. The beam correction function is equivalent to the response of the WTRU's averaging function to the estimated gain difference, offset by the same estimated gain difference.

### CROSS REFERENCE TO RELATED APPLICATION

This application claims the benefit of U.S. Provisional Application No. 60/685,246 filed May 27, 2005, which is incorporated herein by reference as if fully set forth.

### FIELD OF INVENTION

The present invention relates generally to power control in a wireless communication system. More specifically, the present invention relates to uplink power control optimization of a wireless transmit/receive unit (WTRU) utilizing a switched beam antenna.

### BACKGROUND

A switched beam antenna system comprises a plurality of fixed directional antenna beams. A signal quality metric is used to evaluate the signal quality of the various fixed beams. This metric could be signal-to-interference ratio (SIR), received signal strength indicator (RSSI), or some other signal quality metric. The beams are compared based on the measured quality metric and the best beam is chosen for transmission.

Switched beam antennas, when used at a base station or access point, provide several benefits such as reduced transmission power, higher data rates at the cell edge, and increased network capacity, for example. When a switched beam antenna is incorporated into a WTRU, (for example a cell phone, laptop, personal digital assistant (PDA), and user equipment (UE) in general), improved transmission performance of the WTRU and power conservation are clear advantages. However, the incorporation of switched beam antennas in WTRUs presents possible uplink power control problems.

The use of a switched beam antenna in a WTRU requires signal level measurements on each of the directional beams in order to select the best beam. The WTRU then periodically selects the most desirable beam to accommodate environment changes typically resulting from movement of the WTRU. When the WTRU switches beams, there may be an abrupt change in the power of the received signal at the WTRU (downlink), and/or the received signal at the base station or access point (uplink). These power fluctuations can result in receiver performance degradation and potentially lead to a near/far problem. Even though these effects are transient and will usually be corrected over time, it is desirable to minimize these effects. The problem is more pronounced when switching between beams that are far apart in a predefined beam pattern, such as switching directly from a left beam to a right beam in a three-beam system.

Transmit power control (TPC) controls the transmission power of a WTRU so that fluctuations in the power level received at the base station are minimal. In a CDMA system, for example, a WTRU uses TPC to minimize the near/far problem by assuring that all WTRUs achieve the same received power levels at the base station. Power control in the uplink further allows a WTRU to optimize battery power consumption. In the downlink, power control reduces intra-cell and inter-cell interference.

Uplink transmit power is usually initialized to some value while making assumptions regarding the channel conditions. This initial value is given, for example, in the case of W-CDMA or CDMA2000, by standard measurements and equations. A power control algorithm is then implemented to make any necessary adjustments to reflect actual channel conditions. The power control algorithm may take several iterations to converge the transmit power to a desired value.

Transmit power control can be classified generally into two categories. The first, open loop power control, measures received signal power and uses these measurements to adjust transmit power. The second, closed loop power control, uses feedback from a transceiver to control transmit power. In this type of TPC, a base station transceiver sends power control bits to a WTRU instructing the WTRU to adjust transmission power in predetermined increments.

Closed loop power control typically comprises an inner loop power control, also referred to as fast power control, and an outer loop power control, also referred to as slow power control. The inner loop power control is responsible for sending power control bits from a base station to a WTRU. The WTRU's transmit power is adjusted up or down incrementally based on the control bits. For example, in a CDMA2000 system, a base station determines which bit to send (i.e. increase or decrease transmit power) based on the measured Eb/Nt and the Eb/Nt set-point (target Eb/Nt); in a W-CDMA system, the determination is based on the measured SIR and SIR set-point (SIR target).

The outer loop power control is responsible for determining and adjusting the set-point value (i.e., the target Eb/Nt for CDMA2000 or the target SIR for W-CDMA). The WTRU chooses the initial set point values based on the Quality of Service (QoS) requirements provided by the network (e.g., target frame error rate (FER) for CDMA2000 and target block error rate (BLER) for W-CDMA) and other factors. The target set point is then adjusted up or down by the WTRU's outer loop power control based on the measured QoS. After several iterations of the inner and outer loop power control, the transmit power converges to a desired value.

Adaptive closed loop power control combines open loop power control and closed loop power control. CDMA2000 is a communication system that utilizes this combined power control mechanism. In this adaptive power control mechanism, a WTRU determines its initial transmission power based on received transmission power measurements (open loop power control). The transmission power is then adjusted based on both power control bits sent from the base station to the WTRU (closed loop power control) and received transmission power measurements performed by the WTRU (open loop power control.)

In a CDMA2000 system, for example, a WTRU measures the received power of a non-power-controlled pilot channel beacon. The pilot channel power measurements are averaged and this average value is used to estimate path loss, to reduce drastic, temporary changes in transmission power, as well as to separate valid signals from noise. Higher mean input power implies lower path loss, and lower mean input power implies higher path loss. Open loop power control adjusts transmit power in a direct relationship to path loss; that is, lower path loss results in lower transmit power and higher path loss results in higher transmit power. In a CDMA2000 system, power control bit updates are also used (i.e., closed loop power control). The path loss calculation is updated at every transmission even though the path loss response is much slower than the power control bit updates, depending on the averaging method and the averaging window time frame.

Referring to FIG. 1, a graphical illustration demonstrating the received power fluctuations at the base station when a WTRU having a switched beam antenna switches beams is shown generally at 100. For simplicity, the WTRU is stationary with respect to the base station and the illustration ignores the effects of closed loop power control (i.e. power control bits sent by the base station to correct the WTRU's transmit power based on the measured Eb/Nt and the Eb/Nt set-point, and set-point changes in response to the gain of the new beam.)

In region 110, the received power at the base station is indicated by line 115. At the time the WTRU switches beams, t_{BeamSwitch}, a surge in received power proportional to the difference in gain between the old beam and the new beam occurs. The received power at the base station 115 eventually returns to its initial value as the transmit power control mechanism reacts to the step change in antenna gain. In region 120, the averaged power of the pilot channel beacon received by the WTRU 125 reflects the change in gain, possibly at a slower rate due to the averaging method that a WTRU employs to reduce severe fluctuations in the received pilot channel, according to the averaging method employed by the WTRU. The full difference in gain ΔG will be reflected in the averaged power of the pilot channel received by the WTRU after some time interval, depending on the characteristics of the averaging method employed by the WTRU. In region 130, the WTRU responds to the gain difference by gradually reducing its transmission power as shown by line 135.

Therefore, it is desired to have a method to optimize the uplink power control in a WTRU having a switched beam antenna to avoid abrupt transmission power changes resulting from beam switching.

### SUMMARY

The present invention is a method for adjusting the transmission power of a WTRU having a switched beam antenna. In order to avoid abrupt power changes received at the base station, and thereby avoid a potential near/far problem, the present invention optimizes the uplink transmission power upon beam switching. The method measures the received power of a non-power controlled transmission from a base station using the various directional beams comprising the switched beam antenna, calculates a beam correction function based on the estimated difference in beam gain before and after beam switching, and implements the beam correction function upon beam switching. The beam correction function is applied for a period of time equal to the time required for the gain difference to be reflected in the averaged power of a pilot channel beacon received by the WTRU. The beam correction function is the averaged power of the pilot channel beacon received by the WTRU offset by the gain difference between beams.

### BRIEF DESCRIPTION OF THE DRAWINGS

A more detailed understanding of the invention may be had from the following description of a preferred embodiment, given by way of example and to be understood in conjunction with the accompanying drawing wherein:

FIG. 1 is a graphical illustration of the received power at the base station, the transmit power of the WTRU, and the averaged power of the pilot channel beacon received by the WTRU in response to a beam switch where the gain of the new beam is higher than the gain of the old beam;

FIG. 2 is a flow diagram of the method for optimizing transmission power in the uplink of a WTRU having a switched beam antenna by using a beam correction function according to the present invention; and

FIG. 3 is a graphical illustration of the received power at the base station, the transmit power of the WTRU, and the averaged power of the pilot channel beacon received by the WTRU when a beam correction function is applied to the transmit power algorithm of a WTRU according to the present invention.

### DETAILED DESCRIPTION OF THE PREFERRED EMBODIMENTS

The present invention will be described in more detail with reference to the drawing figures wherein like numerals indicate like elements throughout.

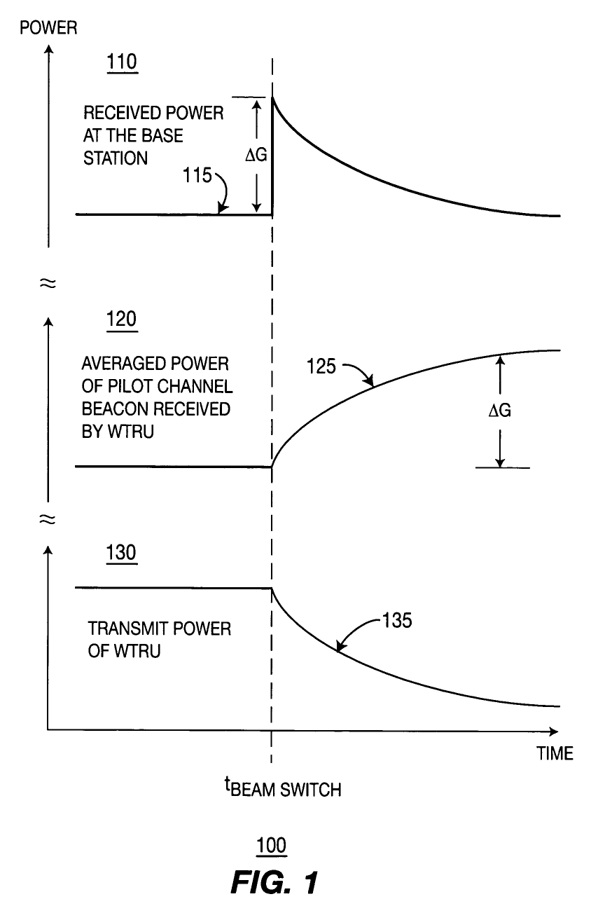

The present invention optimizes the uplink power control algorithm used by a WTRU having a switched beam antenna in order to avoid the high variance in uplink transmission power during beam switching. The optimization method avoids “blast” in the base station received power, where a sudden increase in uplink transmission power is likely to cause a near-far problem, as shown in FIG. 1 and discussed hereinabove. The method further avoids deep fades where the uplink transmission power becomes very low after beam switching.

In a WTRU utilizing open loop power control as a component of TPC, the WTRU may average power measurements of transmissions from a base station. Various methods exist for averaging the transmission power measurements, such as a moving window average or an exponential average. Each type of averaging method provides specific benefits and associated drawbacks as compared to other averaging methods. A WTRU may implement any type of averaging method, as desired. The methods used by WTRUs to average transmission power are not standardized, and therefore these methods vary. The present invention is intended to work with any of these methods.

As described hereinbefore, when a WTRU having a switched beam antenna switches beams, the antenna gain will most likely change after beam switching. If the WTRU's transmission power remains constant at the time the antenna gain changes, the power received by the base station will fluctuate. In this case, an adjustment in the transmit power level of the WTRU is required at the time of beam switching.

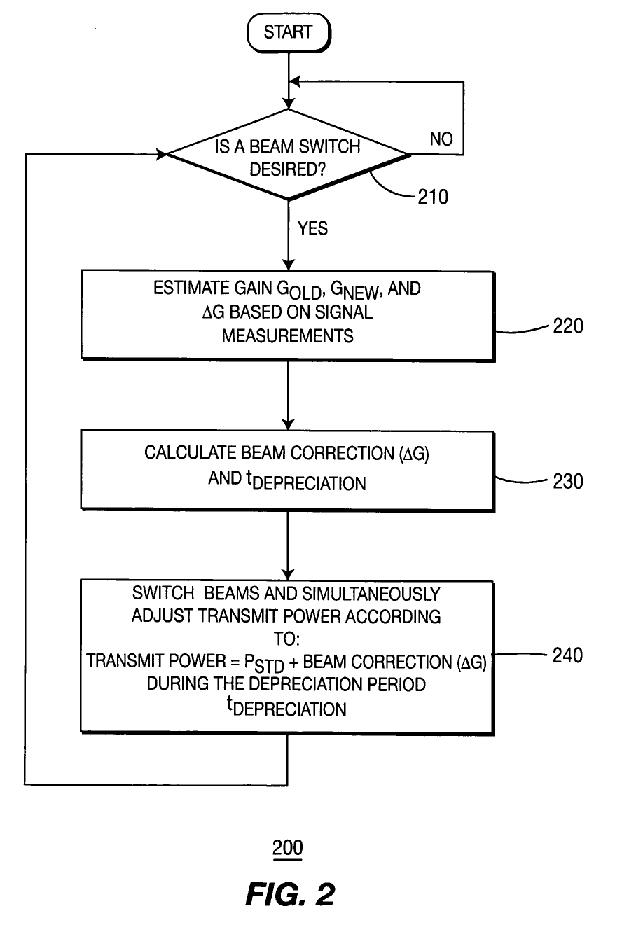

Referring to FIG. 2, a flow diagram of method 200 for optimizing transmission power according to a currently preferred embodiment of the present invention is shown. The method 200 begins by determining whether a beam switch is desired, (step 210). There are many factors considered by a WTRU having a switched beam antenna when determining whether a beam switch is desired. Typically, a beam switch is desired when the channel condition on a beam which is not being utilized is better than the beam currently being utilized. For example, the WTRU may measure the signal power of a pilot channel received on each of N directional antenna beams, B₁, B₂ . . . B_{N}, and estimate path loss P₁, P₂ . . . P_{N}, for each beam based on the signal power measurements. Based on the estimated path loss, the WTRU decides whether a beam switch is desired.

It should be understood by those skilled in the art that signal quality metrics other than path loss, such as Signal to Noise Ratio, Signal to Interference Ratio, Packet Error Ratio, and other quality metrics, may be used alone or in combination as a basis for switching beams. Furthermore, a decision to switch beams may be based upon measurements of signals received on channels other than the pilot channel, such as a dedicated channel. Measurements of this kind would then be used estimating the gain of the directional antenna beams. Although other channels may be power controlled, if measurements of different beams are made very close in time, an adequate estimation of the beam gain difference ΔG can be made.

If a beam switch is desired, the gain of the current beam G_{old}, the gain of the new beam to which the WTRU has decided to switch G_{new}, and a gain difference ΔG between the old beam and the new beam are estimated based on signal power measurements, (step 220). The signal power measurements used for the various gain estimations are preferably the same signal power measurements made in order to evaluate the N directional antenna beams comprising the switched beam antenna. However, if no signal power measurements are made prior to beam switching, it may be necessary to make signal power measurements for gain estimates. Using the estimated gain difference ΔG, a beam correction function is calculated as well as the depreciation period, t_{depreciation}, (step 230). The depreciation period t_{depriciation} is the amount of time required for the gain of the new beam to be reflected in the measured averaged power of the pilot channel beacon received by the WTRU, and the duration the beam correction function is applied to correct the WTRU's transmit power. The WTRU then switches beams and simultaneously adjusts its transmission power in accordance with the beam correction function during the depreciation period, t_{depriciation}, (step 240). The beam correction function depends on the type of averaging method employed by the WTRU, but will only require two variables; the gain of the new beam to which the WTRU is switching G_{new} and the gain of the old beam from which the WTRU is switching G_{old}, or simply a gain difference ΔG.

Upon beam switching, the WTRU's transmission power will be the transmission power determined by the standards, for example CDMA2000, adjusted by the beam correction function. Let P_{std} be the WTRU's transmission power determined by the standards. The WTRU calculates the transmit power as follows:
TransmitPower(t)=P_{std}+BeamCorrection(t−t_{BeamSwitch}); (1)
where t_{BeamSwitch} is the time the WTRU switches beam, and;
BeamCorrection(0)=G_{old}−G_{new}=ΔG. (2)
Since the difference in beam gain between the old beam and the new beam will be reflected in the average power of the pilot channel beacon received by the WTRU, the beam correction function will reach zero after the depreciation period. Thus:
BeamCorrection(t_{depreciation})=0. (3)

The length of the depreciation period and the amount depreciated at every time will depend on the average method used by the WTRU to calculate the mean input power. This is due to different averaging methods that inherently provide different convergence time periods. The objective is to create a situation where the base station receives the same transmission power as it would if there was no beam switching while the WTRU can transmit at a much lower power, resulting in lower battery power consumption.

Let AveragePower(.) be the function used by the WTRU to average the power of the received pilot channel beacon. The beam correction function is equivalent to the response of the averaging function, AveragePower(.), to a step change in gain between a first beam and a second beam, AveragePower(ΔG), offset by this same difference in gain:
BeamCorrectionFunction=AveragePower(ΔG)−ΔG (4)

Accordingly, when a step change in the antenna gain, ΔG, is introduced, the beam correction function will respond in an identical manner to the average input power of the pilot channel received by the WTRU. The beam correction function is calculated at the time of beam switching using the estimated ΔG. For example, where a WTRU utilizes a simple moving window average technique to average the input power of the pilot channel received from the base station, the beam correction function is the same moving window average algorithm.

In order to illustrate this, assume an initial estimated beam gain of 0, and an estimated beam gain of G upon beam switching. Where a WTRU has a moving average window length of 3, the moving window average at each time interval would be: at time zero, (0+0+0)/3=0; at time 1, (0+0+G)/3=G/3; at time 2, (0+G+G)/3=2G/3; and finally at time 3, (G+G+G)/3=G. Applying Equation 4 to yield a beam correction function yields −G at time 0, G/3−G at time 1, 2G/3−G at time 2, and G−G=0 at time 3. Applying Equation (3), time 3 would be t_{depriciation}, and the beam correction function is used to adjust the standard transmit power P_{std} from t to t_{depriciation} according to Equation (1).

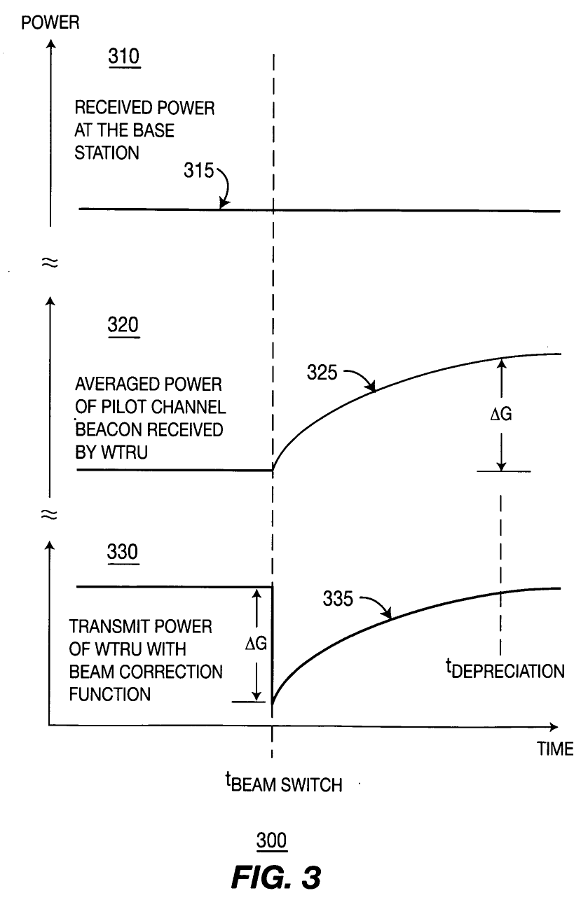

Referring to FIG. 3, a graphical illustration of the received power at the base station when a beam correction function is applied in accordance with the present invention is shown generally at 300. It should be noted that the illustration shown in FIG. 3 is simplified in that the WTRU is stationary with respect to the base station and the illustration ignores the effects of closed loop power control (i.e. power control bits sent by the base station to correct the WTRU's transmit power based on the measured Eb/Nt and the Eb/Nt set-point, and set-point changes in response to the gain of the new beam.). In region 310, the received power at the base station 315 remains constant. In region 320, the averaged power of the pilot channel beacon as received by the WTRU 325 slowly increases after the beam switch. In region 330, the transmit power of the WTRU with the beam correction function applied is indicated by line 335. It can be seen that at t_{BeamSwitch}, the transmit power is offset by the difference in gain between the two beams. The beam correction function is applied until t_{Depriciation}, where the gain difference ΔG is reflected in the averaged power of the pilot channel beacon received by the WTRU 325.

The method of the present invention does not prevent a WTRU with a switched beam antenna from increasing its transmission power by adjusting, via outer-loop power control, the target set-point parameters. Accordingly, a switched beam antenna can be used to increase a WTRU's transmission power while avoiding the near/far problem. An advantage of the present invention is that the received transmission power at the base station is maintained relatively constant, and gradual changes can occur through typical power control mechanisms while avoiding the near/far problem. Furthermore, although the invention has been described in the context of correcting a blast of power as received at the base station, the invention is not limited thereto, and may be used to correct deep fades.

Although the present invention has been described with reference to the preferred embodiments, those skilled in the art will recognize that changes may be made in form and detail without departing from the spirit and scope of the invention.

What is claimed is:

1. A method for optimizing uplink transmission power upon beam switching of a wireless transmit/receive unit- (WTRU) having a switched beam antenna comprising a plurality of directional beams, the method comprising the steps of:
(a) estimating a gain difference between a first beam and a second beam to which the WTRU has decided to switch;
(b) calculating a beam correction function based on the estimated gain difference; and
(c) switching beams while simultaneously adjusting transmission power according to the calculated beam correction function.

2. The method of claim 1 wherein step (a) further comprises:
i. receiving a first transmission on a first beam;
ii. measuring a first signal characteristic of the first transmission received on the first beam;
iii. receiving a second transmission on a second beam;
iv. measuring a second signal characteristic on a second beam received on the second beam; and
v. estimating a gain of the first beam and a gain of the second beam using said first and second measured signal characteristics.

3. The method of claim 2 wherein the first and second transmissions are the same transmission.

4. The method of claim 2 wherein the first and second transmissions are pilot channel beacons.

5. The method of claim 4 wherein the pilot channel beacons are not power controlled.

6. The method of claim 2 wherein the measured signal characteristic of the first and second transmissions is power received at the WTRU.

7. The method of claim 1 wherein the WTRU receives a plurality of transmissions, measures the power of the received transmissions, and averages the received power measurements in accordance with an averaging algorithm, and wherein the beam correction function is the response of the averaging algorithm to the estimated difference in gain, offset by the estimated difference in gain.

8. The method of claim 7 wherein the beam correction function is used to adjust the WTRU's transmission power during a depreciation period.

9. The method of claim 8 wherein the depreciation period is the length of time required for the averaging algorithm to reflect the change in gain.

10. The method of claim 1 wherein the WTRU is operating in accordance with the CDMA2000 standards.

11. The method of claim 1 wherein the WTRU is operating in accordance with the W-CDMA standards.

12. The method of claim 1 wherein the WTRU is operating in accordance with the TDD-CDMA standards.

13. The method of claim 1 wherein the WTRU is operating in accordance with the FDD-CDMA standards.
